(19) United States
(12) Patent Application Publication
(10) Pub. No.: US 2024/0201879 A1
(43) Pub. Date: Jun. 20, 2024

(54) STORAGE DEVICE, STORAGE DEVICE OPERATING METHOD AND RESOURCE MANAGEMENT DEVICE FOR DETERMINING UNIT OF DATA REQUIRED FOR OPERATION OF RESOURCES OF STORAGE DEVICE BASED ON ACCESS PATTERN OF HOST DEVICE

(71) Applicant: SAMSUNG ELECTRONICS CO., LTD, Suwon-si (KR)

(72) Inventors: Inkyu Kim, Suwon-si (KR); Dongchan Lee, Suwon-si (KR)

(73) Assignee: SAMSUNG ELECTRONICS CO., LTD, Suwon-si (KR)

(21) Appl. No.: 18/237,534

(22) Filed: Aug. 24, 2023

(30) Foreign Application Priority Data
Dec. 16, 2022 (KR) 10-2022-0177331

(51) Int. Cl. G06F 3/06

(52) U.S. Cl. CPC G06F 3/0631; G06F 3/0604; G06F 3/0679

(57) ABSTRACT

A method of operating a storage device includes receiving a request of a host device, determining a unit of data required for one operation of resources of the storage device based on an access pattern of the host device included in the request and a minimum data unit by which a non-volatile memory included in the storage device operates, and performing an operation, by the resources of the storage device, based on the determined unit.

### CROSS-REFERENCE TO RELATED APPLICATION

This application is based on and claims priority under 35 U.S.C. § 119 to Korean Patent Application No. 10-2022-0177331, filed on Dec. 16, 2022, in the Korean Intellectual Property Office, the disclosure of which is incorporated by reference herein in its entirety.

### BACKGROUND

### 1. Field

Embodiments of the disclosure relate to a storage device, a storage device operation method, and a resource management device, and in particular, to an method of operating resources of the storage device based on a memory access pattern.

### 2. Description of Related Art

A storage system includes a host and a storage device, and the storage device may include, for example, a non-volatile memory such as a flash memory and a storage controller controlling the non-volatile memory. The storage device may provide data stored in the non-volatile memory to the host according to a read request from the host. The storage device may perform a sequential read operation on the non-volatile memory when read requests for consecutive addresses are received from the host. At this time, the storage controller may improve read performance by prefetching data from the non-volatile memory.

### SUMMARY

Embodiments of the disclosure provide a storage device, a storage device operation method, and a resource management device that allow resources required for a sequential access or a random access of a specific or larger size to operate in a minimum data unit by which non-volatile memory operates.

According to an aspect of the disclosure, there is provided a method of operating a storage device including a non-volatile memory, the method including: receiving a request from a host device: determining a unit of data for performing one operation of one or more resources of the storage device based on an access pattern of the host device included in the request and a minimum data unit by which the non-volatile memory operates: and performing an operation, by the one or more resources of the storage device, based on the determined unit of data.

According to another aspect of the disclosure, there is provided a storage device including: a non-volatile memory: and a storage controller configured to: receive a request from a host device: determine a unit of data for performing one operation of one or more resources of the storage device based on an access pattern of the host device included in the request and a minimum data unit by which the non-volatile memory operates: and cause the one or more resources of the storage device to perform an operation based on the determined unit of data.

According to an aspect of the disclosure, there is provided a resource management device including: a memory storing instructions to perform a resource management operation: and at least one processor configured to execute the instructions to: receive a request from a host device; determine a unit of data for performing one operation of one or more resources of a storage device based on an access pattern of the host device included in the request and a minimum data unit by which a non-volatile memory included in the storage device operates; and perform an operation, by the one or more resources of the storage device, based on the determined unit of data.

### BRIEF DESCRIPTION OF DRAWINGS

Embodiments will be more clearly understood from the following detailed description taken in conjunction with the accompanying drawings in which:

FIG. 1 is a block diagram illustrating a storage system according to an embodiment;

FIG. 2 is a flowchart illustrating a method of operating a storage device according to an embodiment;

FIG. 3 is a conceptual diagram for explaining a sequential access and a random access;

FIG. 4 is a flowchart illustrating a method of operating a storage device according to an embodiment;

FIG. 5 is a conceptual diagram illustrating a prefetching operation method between a host device and a storage device according to an exemplary embodiment;

FIG. 6 is a block diagram illustrating a host-storage system according to an embodiment; and

FIG. 7 is a block diagram of a resource management device according to an embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the disclosure are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the disclosure.

It will be understood that when a component is referred to as being “connected to” another component, the component can be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. As used herein, expressions such as “at least one of” when preceding a list of elements, modify the entire list of elements and do not modify the individual elements of the list. For example, the expression, “at least one of a, b, and c” should be understood as including only a, only b, only c, both a and b, both a and c, both b and c, or all of a, b, and c.

Unless otherwise defined, all terms including technical or scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals assigned to the elements in the drawings, it should be noted that the same elements will be designated by the same reference numerals, and redundant descriptions thereof will be omitted.

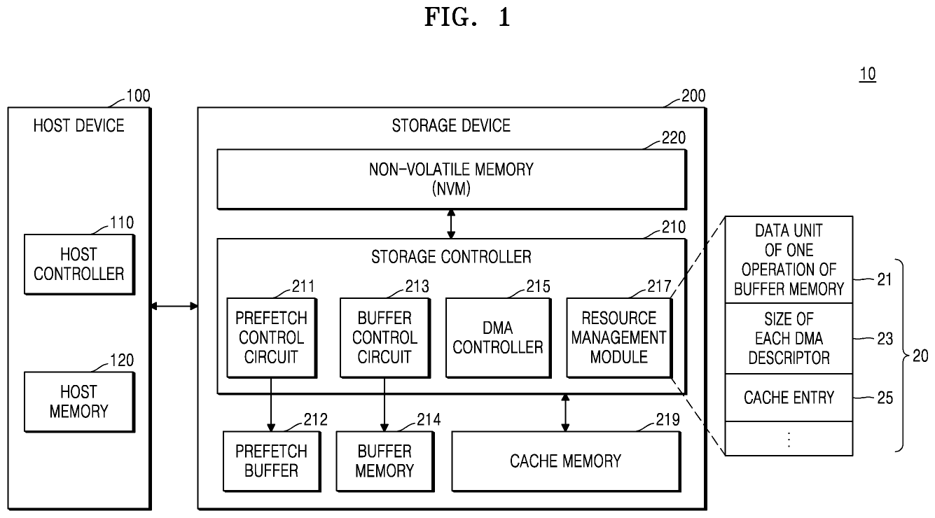

FIG. 1 is a block diagram illustrating a storage system according to an embodiment.

Referring to FIG. 1, a storage system 10 may include a host device 100 and a storage device 200. The storage device 200 may include a storage controller 210 and a non-volatile memory (NVM) 220. According to an embodiment, the storage controller 210 may also be referred to as a controller, a device controller, or a memory controller. According to an embodiment, the NVM 220 may be implemented as a plurality of memory chips or a plurality of memory dies. For example, each of the plurality of memory chips may be a dual die package (DDP), quadruple die package (QDP), or octuple die package (ODP). However, the disclosure is not limited thereto, and as such, the NVM 220 may be implemented in another manner. The host device 100 may include a host controller 110 and a host memory 120. The host memory 120 may function as a buffer memory. For example, the buffer memory may temporarily store data to be transmitted to the storage device 200 or store data received from the storage device 200.

The storage device 200 may include storage media storing data according to a request from the host device 100. For example, the storage media may be configured to store data according to a request, a command or a signal from the host device 100. As an example, the storage device 200 may include at least one of a solid state drive (SSD), an embedded memory, or a removable external memory. When the storage device 200 is an SSD, the storage device 200 may be a device conforming to the non-volatile memory express (NVMe) standard. When the storage device 200 is an embedded memory or an external memory, the storage device 200 may be a device conforming to the universal flash storage (UFS) standard or the embedded multi-media card (eMMC) standard. Each of the host device 100 and the storage device 200 may generate and transmit a packet according to an adopted standard protocol.

When the NVM 220 of the storage device 200 includes a flash memory, the flash memory may include a two-dimensional (2D) NAND memory array or a three dimensional (3D) (or vertical) NAND (VNAND) memory array. As another example, the storage device 200 may include other various types of NVMs. For example, the storage device 200 may include magnetic RAM (MRAM), spin-transfer torque MRAM, conductive bridging RAM (CBRAM), ferroelectric RAM (FeRAM), phase RAM (PRAM), resistive memory and other various types of memory.

The storage controller 210 may control the NVM 220 to perform various operations. For example, the storage controller 210 may control the NVM 220 to write data to the NVM 220 in response to (or based on) a write request from the host device 100 or to read data stored in the NVM 220 in response to (or based on) a read request from the host device 100.

According to an embodiment, the storage controller 210 may include a prefetch control circuit 211, a buffer control circuit 213, a direct memory access (DMA) controller 215, and a resource management module 217. Moreover, the storage device 200 may include a prefetch buffer 212, a buffer memory 214 and a cache memory 219. However, the disclosure is not limited thereto, and in some embodiments, the prefetch buffer 212, the buffer memory 214, or the cache memory 219 may be provided in the storage controller 210. Although FIG. 1 illustrates an arrangement of components in the storage device 200 and a storage controller 210, the disclosure is not limited thereto, and as such, according to another embodiment, one or more of the components in the storage controller 210 may be provided outside of the storage controller, and/or one or more other components may be included in the storage controller 210.

The prefetch control circuit 211 may control a data prefetching operation during a sequential read operation on the NVM 220. According to an embodiment, the prefetch control circuit 211 may dynamically control the data prefetching operation during the sequential read operation on the NVM 220. Here, the “sequential read operation” denotes read operations corresponding to consecutive addresses. For example, in sequential read operation, when the storage controller 210 receives a first read command and a first address from the host device 100 and subsequently receives a second read command and a second address from the host device 100, a start point of the second address may correspond to a logical block address (LBA) right after a last LBA of the first address. In this regard, the storage controller 210 may determine that read operations corresponding to the first and second read commands are sequential read operations. Here, the “data prefetching operation” is an operation of previously reading data corresponding to a read command and address not yet received from the host device 100 from the NVM 220 and buffering the data in the prefetch buffer 212. During the sequential read operation, data read performance may be improved through the data prefetching operation.

Specifically, the prefetch control circuit 211 may dynamically select a transfer path of data provided from the NVM 220 to the host device 100 as a normal data path (NDP) or a prefetch data path (PDP) based on a dynamic control of the data prefetching operation during the sequential read operation. The “NDP” may correspond to a data transfer path transferred from the NVM 220 to the host device 100 in response to a read command and an address received from the host device 100. The “PDP” may correspond to a data transfer path transferred from the NVM 220 to the prefetch buffer 212 and then from the prefetch buffer 212 to the host device 100 in response to a prefetch command generated by the storage controller 210.

The buffer control circuit 213 may control the operation of the buffer memory 214, and the buffer memory 214 may temporarily store data to be written to the NVM 220 or data to be read from the NVM 220.

In an embodiment, the buffer control circuit 213 may control the operation of the buffer memory 214 based on a unit of data required for one operation of resources determined by a resource management module to be described below. For example, a unit of data may be a data unit allocated to perform one operation of the buffer memory 214 as indicated by information 21. However, the disclosure is not limited to one operation of the buffer memory 214, and as such, according to another embodiment, the one operation of the resource may include one read operation, one write operation, one prefetch operation, or one operation of any the component in the storage device 200.

The DMA controller 215 may control the operation of the storage device 200 to provide DMA to a peripheral device. Here, DMA (or DMA operation) indicates that a peripheral device directly accesses the NVM 220 of the storage device 200 independently of the host controller 110 (e.g., central processing unit (CPU)) of the host device 100.

In an embodiment, the DMA controller 215 may control the operation of the storage device 200 based on a DMA descriptor. Here, the DMA descriptor may include certain variables for controlling data input/output operations of the storage device 200. The DMA controller 215 may control input/output of the storage device 200 according to variables included in the DMA descriptor. In addition, certain variables included in the DMA descriptor may be previously set (e.g., preset variables) for the operation of the DMA controller 215. In addition, while the DMA controller 215 operates according to preset variables, variables for the next operation of the DMA controller 215 may be previously set. In addition, DMA descriptors may be stored in the NVM 220, and may be stored in a series of consecutive chains in a manner in which a plurality of DMA descriptors sequentially indicate the next DMA descriptor.

On the other hand, in an embodiment, the DMA controller 215 may control the operation of the storage device 200 based on a unit (e.g., information 23 indicating a data size of each DMA descriptor allocated to one operation of the DMA controller 215) of data required for one operation of resources determined by a resource management module to be described below.

The resource management module 217 may determine the unit of data required for one operation of resources of the storage device 200 based on an access pattern of the host device 100 included in a request from the host device 100. Also, the resource management module 217 may control the storage device 200 so that the resources of the storage device 200 perform an operation based on the determined unit of data.

Here, the resource of the storage device 200 may represent hardware required for the storage device 200 to operate. For example, the resource of the storage device 200 may include the prefetch control circuit 211, the prefetch buffer 212, the buffer control circuit 213, the buffer memory 214, the DMA controller 215, or the cache memory 219.

Referring to FIG. 1, an example of resource management information 20 used by the resource management module is shown. Here, the resource management information 20 represents information required for the resource management module 217 to manage resources of the storage device 200. However, the disclosure is not limited thereto, and as such, the resource management module 217 may include a different format.

Referring to FIG. 1, for example, the resource management information 20 may include information 21 about the unit of data allocated to one operation of the buffer memory 214 corresponding to the buffer control circuit 213, information 23 about the data size of each DMA descriptor allocated to one operation of the DMA controller 215 or information 25 about a size of a cache entry which is the minimum logical unit for dividing data of the cache memory 219.

The resource management module 217 may control operations of resources of the storage device 200 based on the resource management information 20.

In an embodiment, the resource management module 217 may determine information 25 about the size of the cache entry which is the minimum logical unit for dividing data of the cache memory 219 based on an access pattern of the host device 100, and may control a cache memory to operate based on the determined information 25 indicating the size of the cache entry.

Also, the resource management module 217 may generate resource management information to control operations of resources of the storage device 200.

In an embodiment, the resource management module 217 may generate resource management information (e.g., a unit of data required for one operation of resources) based on the access pattern of the host device 100 included in a request from the host device 100.

In this regard, a method in which the resource management module 217 determines a unit of data required for one operation of resources of the storage device 200 based on the access pattern of the host device 100 included in the request from the host device 100 is described in detail with reference to other drawings.

Meanwhile, the resource management module 217 described above may be implemented in software, hardware, or a combination of hardware and software. In an embodiment, the resource management module 217 described above may be implemented in the form of an operating system (OS) or software of a lower level thereof, may also be implemented in programs loadable to a memory provided in an electronic system, and may be executed by at least one processor of the electronic system.

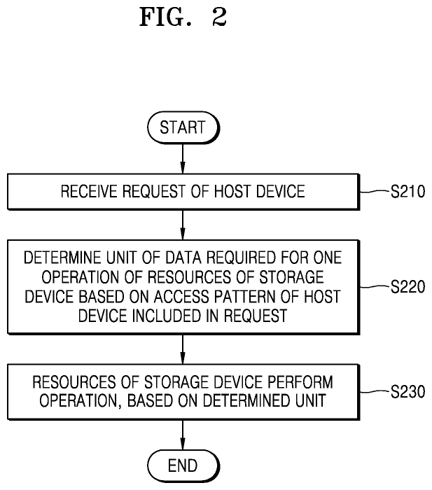

FIG. 2 is a flowchart illustrating a method of operating the storage device 200 according to an embodiment.

Referring to FIG. 2, in operation S210, the storage device 200 may receive a request from the host device 100. Here, the request may indicate a request for the storage device 200 to perform a specific operation on specific data. For example, the request may be a request for the storage device 200 to perform a read or write operation on specific data.

Referring to FIG. 2, in operation S220, the storage device 200 may determine a unit of data required for one operation of resources of the storage device 200 based on an access pattern of the host device 100 included in the request.

Also, in an embodiment, the storage device 200 may determine data required for one operation of the resources of the storage device 200 based on the access pattern of the host device 100 and a minimum data unit by which an NVM included in the storage device 200 operates.

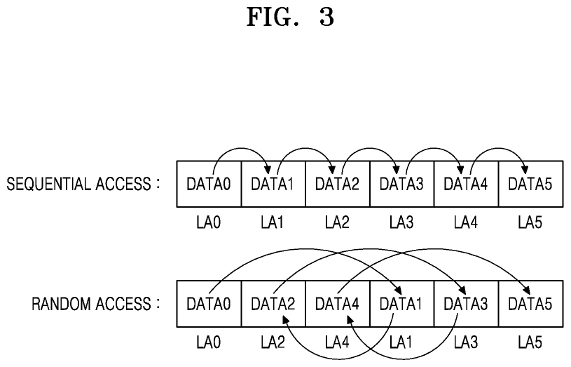

Here, the access pattern of the host device 100 may be divided into a sequential access and a random access, which is described with reference to FIG. 3.

FIG. 3 is a conceptual diagram for explaining a sequential access and a random access.

Referring to FIG. 3, the sequential access and the random access may be based on whether the sequence of logical addresses LA0 to LA5 is continuous or random or based on whether the sequence of access (reading or writing) to data DATA0 to DATA5 stored in storage areas corresponding to the logical addresses LA0 to LA5 is continuous or random.

That is, the sequential access indicates that the sequence of logical addresses LA0 to LA5 is continuous or that the sequence of access to the data DATA0 to DATA5 stored in the storage areas corresponding to the logical addresses LA0 to LA5 is continuous.

On the other hand, the random access indicates that the sequence of logical addresses LA0 to LA5 is random or that the sequence of access to the data DATA0 to DATA5 stored in the storage areas corresponding to the logical addresses LA0 to LA5 is random.

Returning to FIG. 2, the storage device 200 may determine the unit of data required for one operation of the resources of the storage device 200 based on the access pattern of the host device 100 included in the request (S220).

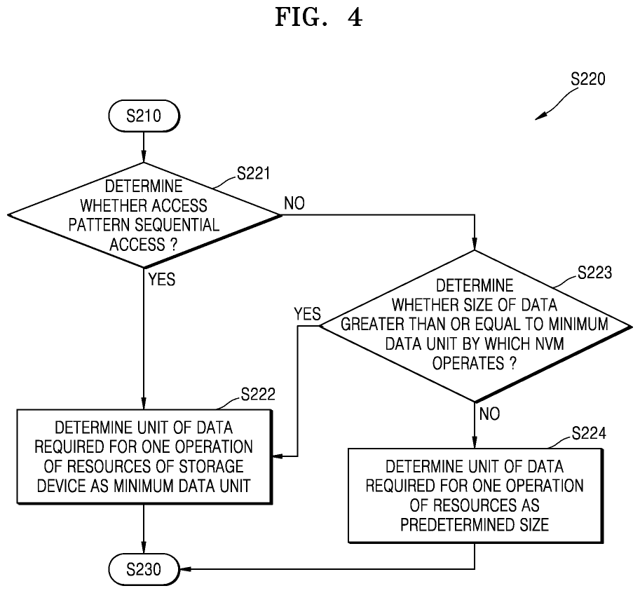

A method in which the storage device 200 determines the unit of data required for one operation of resources of the storage device 200 based on the access pattern of the host device 100 included in the request is described in detail with reference to FIG. 4.

FIG. 4 is a flowchart illustrating a method of operating the storage device 200 according to an embodiment.

Referring to FIG. 4, operation S220 (in FIG. 2) of determining a unit of data required for one operation of resources of the storage device 200 based on an access pattern of the host device 100 included in a request is illustrated in detail.

In an embodiment, the storage device 200 may determine the data required for one operation of resources of the storage device 200 based on the access pattern of the host device 100 and a minimum data unit by which an NVM included in the storage device 200 operates.

In operation S221, the storage device 200 determines whether the access pattern of the host device 100 included in the request from the host device 100 is a sequential access or a random access. When the access pattern of the host device 100 is the sequential access, the process proceeds to operation S222. When the access pattern of the host device 100 is the random access, the process proceeds to operation S223.

In operation S222, the storage device 200 may determine the unit of data required for one operation of the resources of the storage device 200 as the minimum data unit by which the NVM operates. Here, the minimum data unit by which the NVM operates may be, for example, the size of a NAND page.

In operation S223, the storage device 200 determines whether the size of data that is a target of the request from the host device 100 that is a random access is greater than or equal to a size of the minimum data unit by which the NVM operates. When the size of the data that is the target of the request is equal to or greater than the size of the minimum data unit by which the NVM operates, the process proceeds to operation S222. When the size of the data that is the target of the request is not equal to or greater than the size of the minimum data unit by which the NVM operates, the process proceeds to operation S224.

In operation S224, the storage device 200 may determine a size of the unit of data required for one operation of the resources of the storage device 200 as a predetermined size. Here, the predetermined size may be, for example, 4 KB.

In an embodiment, the resource management module 217 may determine the access pattern of the host device 100 included in the request, determine, when the access pattern is the sequential access, the unit of data required for one operation of the resources of the storage device 200 as the minimum data unit by which the NVM operates, determine, when the access pattern is the random access, whether the size of data that is the target of the request from the host device 100 is greater than or equal to a size of the minimum data unit by which the NVM operates, determine, when the access pattern is a random access and the size of the data is greater than or equal to the size of the minimum data unit by which the NVM operates, the size of the unit of data required for one operation of the resources of the storage device 200 as the size of the minimum data unit by which the NVM operates, and determine, when the size of the data is not greater than or equal to the minimum data unit by which the NVM operates and the access pattern is a random access, the size of the unit of data required for one operation of the resources of the storage device 200 as the predetermined size.

Returning to FIG. 2, the storage device 200 may cause the resources of the storage device 200 to perform an operation based on the unit of data required for one operation of the resources determined based on the access pattern of the host device 100 (S230). In an embodiment, the resource management module 217 may cause the buffer control circuit 213 to control an operation of the buffer memory 214 based on the unit of data required for one operation of the resources determined based on the access pattern of the host device 100.

In this regard, when the access pattern is the sequential access, the resource management module 217 may cause the buffer control circuit 213 to control an operation of the buffer memory 214 by using a size of the unit of data required for one operation of the buffer memory 214 as a size of the minimum data unit by which the NVM operates. Here, a size of the minimum data unit by which the NVM operates may be the size of a NAND page.

In addition, when the access pattern is a random access and the size of the data that is the target of the request is greater than or equal to the size of the minimum data unit by which the NVM operates, the resource management module 217 may cause the buffer control circuit 213 to control the operation of the buffer memory 214 by using the unit of data required for one operation of the buffer memory 214 as the minimum data unit by which the NVM operates.

In addition, when the size of the data that is the target of the request is not greater than or equal to the size of the minimum data unit by which the NVM operates and the access pattern is a random access, the resource management module 217 may cause the buffer control circuit 213 to control the operation of the buffer memory 214 by using a predetermined size as a size of the unit of data required for one operation of the buffer memory 214. Here, the predetermined size may be 4 KB. According to an example embodiment, the predetermined size may be different from the size of the minimum data unit by which the NVM operates. For example, the predetermined size may be different from a size of a NAND page. According to an embodiment, the predetermined size may be smaller than the size of the minimum data unit by which the NVM operates.

In an embodiment, the resource management module 217 may cause the DMA controller 215 to control the operation of the storage device 200 based on the unit of data required for one operation of the resources determined based on the access pattern of the host device 100. That is, the resource management module 217 may determine the data size of each DMA descriptor allocated to one operation of the DMA controller 215 based on the access pattern of the host device 100, and the DMA controller 215 may control the operation of the storage device 200 based on the determined data size of each DMA descriptor allocated to one operation.

In this regard, when the access pattern is the sequential access, the resource management module 217 may determine the data size of each DMA descriptor allocated to one operation of the DMA controller 215 as the minimum data unit by which the NVM operates. Here, the minimum data unit by which the NVM operates may be the size of a NAND page.

In addition, when the access pattern is a random access and the size of the data that is the target of the request is greater than or equal to the size of the minimum data unit by which the NVM operates, the resource management module 217 may determine the data size of each DMA descriptor allocated to one operation of the DMA controller 215 as the minimum data unit by which the NVM operates.

In addition, when the size of the data that is the target of the request is not greater than or equal to the size of the minimum data unit by which the NVM operates and the access pattern is a random access, the resource management module 217 may determine the data size of each DMA descriptor allocated to one operation of the DMA controller 215 as the predetermined size. Here, the predetermined size may be 4 KB.

In an embodiment, the resource management module 217 may determine the size of a cache entry, which is a logical minimum unit for dividing data of the cache memory 219, based on the access pattern of the host device 100, and may control the cache memory 219 to operate based on the determined size of the cache entry.

In this regard, when the access pattern is the sequential access, the resource management module 217 may cause the buffer control circuit 213 to determine the size of the cache entry as the minimum data unit by which the NVM operates, and may control the cache memory 219 to operate based on the determined size of the cache entry. Here, the minimum data unit by which the NVM operates may be the size of a NAND page.

In addition, when the access pattern is a random access and the size of the data that is the target of the request is greater than or equal to the minimum data unit by which the NVM operates, the resource management module 217 may cause the buffer control circuit 213 to determine the size of the cache entry as the minimum data unit by which the NVM operates, and may control the cache memory 219 to operate based on the determined size of the cache entry.

In addition, when the size of the data that is the target of the request is not greater than or equal to the minimum data unit by which the NVM operates and the access pattern is a random access, the resource management module 217 may cause the buffer control circuit 213 to determine the size of the cache entry as the predetermined size, and may control the cache memory 219 to operate based on the determined size of the cache entry. Here, the predetermined size may be 4 KB.

According to an embodiment, for a sequential access or a random access of a specific or larger size, resources (e.g., buffer) in the storage device operate in the minimum data unit (e.g., size of a NAND page) by which an NVM operates, which reduces time taken for each resource to operate, and thus, the speed of the storage device 200 may increase. For example, when data of 16 KB size is read, four DMA descriptors each having a 4 KB transmission unit are used and a buffer requires four allocations in a 4 KB unit, and four allocations of cache entry in a 4 KB unit in the related art. However, according to the disclosure, when the size of a NAND page is 16 KB, to read data of 16 KB size, one DMA descriptor is used and a buffer requires one allocation in a 16 KB unit, and one allocation of cache entry in a 16 KB unit, which reduces the time taken for each resource to operate, and thus, the speed of the storage device 200 may increase.

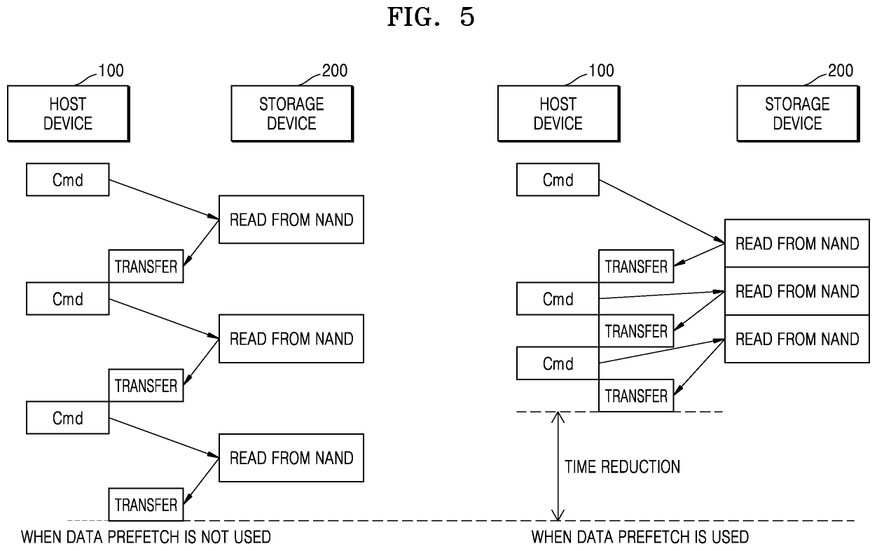

In addition, according to an embodiment, the prefetch control circuit 211 performs a prefetching operation using a sequential access or a random access having a size greater than or equal to a certain size in the minimum data unit (e.g., the NAND page size) in which an NVM operates, and thus, the efficiency of the prefetching operation may be maximized. This is described in detail with reference to FIG. 5.

FIG. 5 is a conceptual diagram illustrating a prefetching operation method between a host device and a storage device according to an exemplary embodiment.

Referring to FIG. 5, it may be seen that an operation according to whether a prefetching operation is performed between the host device 100 and the storage device 200 is illustrated.

Here, the “data prefetching operation” is an operation of reading data from the NVM 220 of the storage device 200 prior to receiving a read command and address from the host device 100, and buffering the data in the prefetch buffer 212.

Specifically, the prefetch control circuit 211 may dynamically select a transfer path of data provided from the NVM 220 to the host device 100 as a NDP or a PDP, by dynamically controlling the data prefetching operation during the sequential read operation. The “NDP” may correspond to a data transfer path transferred from the NVM 220 to the host device 100 in response to a read command and an address received from the host device 100. The “PDP” may correspond to a data transfer path transferred from the NVM 220 to the prefetch buffer 212 and then from the prefetch buffer 212 to the host device 100 in response to a prefetch command generated by the storage controller 210.

In an embodiment, the resource management module 217 may cause the prefetch control circuit 211 to control the operation of the prefetch buffer 212 based on a unit of data required for one operation of resources determined based on an access pattern of the host device 100.

According to an embodiment, the prefetch control circuit 211 performs a prefetching operation using a sequential access or a random access having a size greater than or equal to a certain size in the minimum data unit (e.g., the NAND page size) in which an NVM operates, and thus, the efficiency of the prefetching operation may be maximized. That is, the more prefetching operations are performed, the more time is reduced.

For example, it is assumed that the size of sequential data of 32 KB is read and described. In the case where a basic data unit of buffering of the related art is 4 KB, sequential data of 32 KB size may be sent to a host device in the total of 8 times in which first 4 KB data is sent through the NDP once, and the subsequent 28 KB data is sent through the PDP 7 times. However, according to the disclosure, when the size of a NAND page is 16 KB, sequential data of 32 KB size may be sent to the host device 100 in the total of 2 times in which first 16 KB data is sent through the NDP once, and the subsequent 1 KB data is sent through the PDP once. That is, the more prefetching operations are performed, the more time is reduced.

In addition, according to an embodiment, when data of the same size is transmitted, because the number of times the PDP is used is reduced, the size of data used by the resource management module 217 is reduced. For example, when the resource management module 217 uses 32 bytes for transmission through the PDP, the resource management module 217 uses 32 bytes×4 times=128 bytes to transmit data of the same size through the PDP four times in the related art. However, according to the disclosure, the resource management module 217 may use 32 bytes×1 time=32 bytes to transmit data of the same size through the PDP once

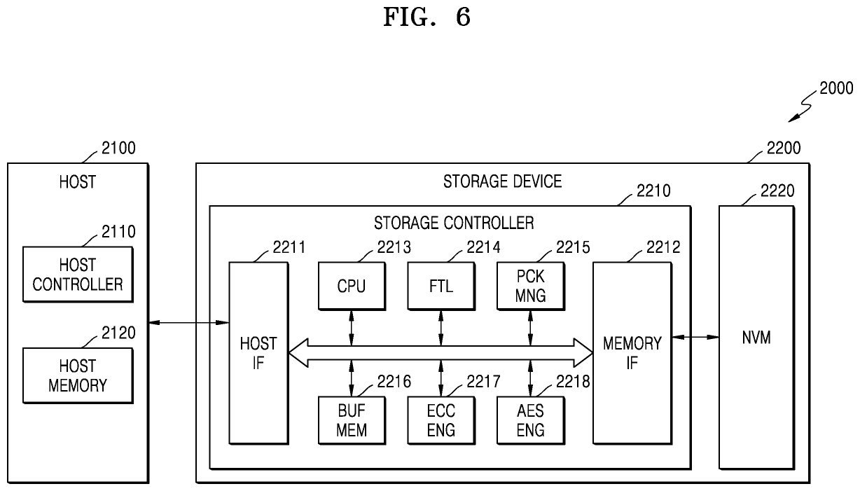

FIG. 6 is a block diagram illustrating a host-storage system 2000 according to an embodiment.

The host-storage system 2000 may include a host 2100 and a storage device 2200. Also, the storage device 2200 may include a storage controller 2210 and an NVM 2220. Also, according to an embodiment, the host 2100 may include a host controller 2110 and a host memory 2120. The host memory 2120 may function as a buffer memory temporarily storing data to be transmitted to the storage device 2200 or data transmitted from the storage device 2200. For example, the NVM 2220 may correspond to the NVM 220 of FIG. 1, the storage controller 2210 may correspond to the storage controller 210 of FIG. 1, and the host 2100 may correspond to the host device 100 of FIG. 1.

The storage device 2200 may include storage media storing data according to a request from the host 2100. As an example, the storage device 2200 may include at least one of a SSD, an embedded memory, or a removable external memory. When the storage device 2200 is an SSD, the storage device 2200 may be a device conforming to the NVMe standard. When the storage device 2200 is an embedded memory or an external memory, the storage device 2200 may be a device conforming to the UFS standard or the eMMC standard. Each of the host 2100 and the storage device 2200 may generate and transmit a packet according to an adopted standard protocol.

When the NVM 2220 of the storage device 2200 includes a flash memory, the flash memory may include a 2D NAND memory array or a 3D VNAND memory array. As another example, the storage device 2200 may include other various types of NVMs. For example, the storage device 2200 may include MRAM, spin-transfer torque MRAM, CBRAM, FeRAM, PRAM, resistive memory and other various types of memory.

According to an embodiment, the host controller 2110 and the host memory 2120 may be implemented as separate semiconductor chips. Alternatively, in some embodiments, the host controller 2110 and the host memory 2120 may be integrated on the same semiconductor chip. As an example, the host controller 2110 may be any one of a plurality of modules included in an application processor, and the application processor may be implemented as a system on chip (SoC). Also, the host memory 2120 may be an embedded memory included in the application processor, or may be an NVM or a memory module disposed outside the application processor.

The host controller 2110 may manage an operation of storing data (e.g., write data) in a buffer area of the host memory 2120 in the NVM 2220 or storing data (e.g., read data) in the NVM 2220 in the buffer area.

The storage controller 2210 may include a host interface 2211, a memory interface 2212, and a central processing unit (CPU) 2213. In addition, the storage controller 2210 may further include a flash translation layer (FTL) 2214, a packet manager 2215, a buffer memory 2216, an error correction code (ECC) engine 2217, and an advanced encryption standard (AES) engine 2218. The storage controller 2210 may further include a working memory (not shown) into which the FTL 2214 is loaded, and may control data write and read operations on the NVM 2220 by the FTL 2214 executed by the CPU 2213.

The host interface 2211 may transmit and receive packets to and from the host 2100. A packet transmitted from the host 2100 to the host interface 2211 may include a command or data to be written to the NVM 2220, and a packet transmitted from the host interface 2211 to the host 2100 may include a response to a command or data read from the NVM 2220. The memory interface 2212 may transmit data to be written to the NVM 2220 to the NVM 2220 or may receive data read from the NVM 2220. The memory interface 2212 may be implemented to comply with a standard protocol such as Toggle or Open NAND Flash Interface (ONFI).

The FTL 2214 may perform various functions such as address mapping, wear-leveling, and garbage collection. Address mapping is an operation of changing a logical address received from the host 2100 into a physical address used to actually store data in the NVM 2220. Wear-leveling is technology for preventing excessive deterioration of a specific block by uniformly using blocks in the NVM 2220, and may be implemented through firmware technology for balancing erase counts of physical blocks Garbage collection is technology for securing usable capacity in the NVM 2220 by copying valid data of a block to a new block and then erasing the old block.

The packet manager 2215 may generate a packet according to an interface protocol agreed with the host 2100 or parse various types of information from a packet received from the host 2100. Also, the buffer memory 2216 may temporarily store data to be written to the NVM 2220 or data to be read from the NVM 2220. The buffer memory 2216 may be included in the storage controller 2210, but may be disposed outside the storage controller 2210.

The ECC engine 2217 may perform error detection and correction functions on read data read from the NVM 2220. More specifically, the ECC engine 2217 may generate parity bits with respect to write data to be written to the NVM 2220, and the generated parity bits may be stored in the NVM 2220 together with the write data. When data is read from the NVM 2220, the ECC engine 2217 may correct an error in the read data by using parity bits read from the NVM 2220 together with the read data, and output the read data of which the error has been corrected.

The AES engine 2218 may perform at least one of an encryption operation or a decryption operation on data input to the storage controller 2210 using a symmetric-key algorithm.

Meanwhile, the storage device 2200 and the host controller 2110 may mutually communicate through a link (not shown) and mutually transmit or receive messages and/or data over the link (not shown). The storage device 2200 and the host controller 2110, as a non-limiting example, may communicate with each other based on coherent interconnect technologies such as a compute express link (CXL) protocol, an XBus protocol, an NVLink protocol, an Infinity Fabric protocol, a cache coherent interconnect for accelerators (CCIX) protocol, and a coherent accelerator (CAPI) protocol.

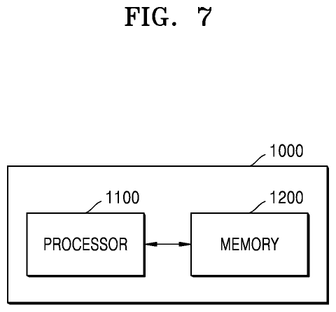

FIG. 7 is a block diagram of a resource management device according to an embodiment.

Referring to FIG. 7, a resource management device 1000 may include a processor 1100 and a memory 1200. FIG. 7 shows one processor 1100, but is not limited thereto, and the resource management device 1000 may include a plurality of processors.

The processor 1100 may include one or more cores (not shown) and a graphics processing unit (not shown) and/or a connection path (e.g., a bus) for transmitting and receiving signals to and from other components.

The processor 1100 may perform the resource management method described above with reference to FIGS. 1 to 5. For example, the processor 1100 of the resource management device 1000 may determine a unit of data required for one operation of resources of a storage device based on an access pattern of a host device included in a request from the host device. Also, the resource management device 1000 may control the storage device so that the resources of the storage device perform an operation based on the determined unit.

Meanwhile, the processor 1100 may further include Random Access Memory (RAM) (not shown) and Read-Only Memory (ROM) (not shown) that temporarily and/or permanently store signals (or data) processed inside the processor 1100. In addition, the processor 1100 may be implemented in the form of a system on chip (SoC) including at least one of a graphics processing unit, RAM, or ROM.

The memory 1200 may store programs (one or more instructions) for processing and control of the processor 1100. For example, the memory 1200 may include a plurality of modules in which the resource management method described with reference to FIGS. 1 to 5 is implemented. Also, the memory 1200 may store instructions to cause at least one processor to perform the resource management method when executed by the at least one processor.

While the inventive concept has been particularly shown and described with reference to embodiments thereof, it will be understood that various changes in form and details may be made therein without departing from the spirit and scope of the following claims.

What is claimed is:

1. A method of operating a storage device including a non-volatile memory, the method comprising:
receiving a request from a host device;
determining a unit of data for performing one operation of one or more resources of the storage device based on an access pattern of the host device included in the request and a minimum data unit by which the non-volatile memory operates; and
performing an operation, by the one or more resources of the storage device, based on the determined unit of data.

2. The method of claim 1, wherein each of the one or more resources comprises at least one of a direct memory access (DMA) controller, a cache memory, or a buffer memory.

3. The method of claim 1, wherein the determining of the unit of data for performing one operation of the one or more resources comprises determining whether the access pattern of the host devices is a sequential access or a random access.

4. The method of claim 3, wherein the determining of the unit of data for performing one operation of the one or more resources comprises determining the unit of data for performing one operation of the resources as the minimum data unit based on the access pattern being the sequential access.

5. The method of claim 3, wherein the determining of the unit of data for performing one operation of the one or more resources comprises determining whether a size of data that is a target of the request is greater than or equal to a size of the minimum data unit based on the access pattern being the random access.

6. The method of claim 5, wherein the determining of the unit of data for performing one operation of the one or more resources comprises determining the unit of data for performing one operation of the one or more resources as the minimum data unit based on the access pattern being the random access and the size of the data being greater than or equal to the size of the minimum data unit.

7. The method of claim 5, wherein the determining of the unit of data for performing one operation of the one or more resources comprises determining the unit of data for performing one operation of the one or more resources as a predetermined size based on the size of the data being not equal to or greater than the size of the minimum data unit and the access pattern being the random access.

8. The method of claim 1, wherein the performing of the operation by the one or more resources comprises controlling, by a direct memory access (DMA) controller, an operation of the storage device based on a data size of each DMA descriptor allocated to one operation determined based on the access pattern of the host device.

9. The method of claim 1, wherein the performing of the operation, by the one or more resources comprises performing the operation, by a cache memory, based on a size of a cache entry determined based on the access pattern of the host device.

10. A storage device comprising:
a non-volatile memory; and
a storage controller configured to:
receive a request from a host device;
determine a unit of data for performing one operation of one or more resources of the storage device based on an access pattern of the host device included in the request and a minimum data unit by which the non-volatile memory operates; and
cause the one or more resources of the storage device to perform an operation based on the determined unit of data.

11. The storage device of claim 10, wherein each of the one or more resources comprises at least one of a direct memory access (DMA) controller, a cache memory, or a buffer memory.

12. The storage device of claim 10, wherein the storage controller is further configured to determine whether the access pattern of the host device is a sequential access or a random access.

13. The storage device of claim 12, wherein the storage controller is further configured to determine the unit of data for performing one operation of the one or more resources as the minimum data unit based on the access pattern being the sequential access.

14. The storage device of claim 12, wherein the storage controller is further configured to determine whether a size of data that is a target of the request is greater than or equal to a size of the minimum data unit based on the access pattern being the random access.

15. The storage device of claim 14, wherein the storage controller is further configured to determine the unit of data for performing one operation of the one or more resources as the minimum data unit based on the access pattern being the random access and the size of the data being greater than or equal to the size of the minimum data unit.

16. The storage device of claim 14, wherein the storage controller is further configured to determine the unit of data for performing one operation of the one or more resources as the minimum data unit based on the size of the data being not equal to or greater than the size of the minimum data unit and the access pattern being the random access.

17. The storage device of claim 10, further comprising:
a direct memory access (DMA) controller,
wherein the DMA controller is configured to control an operation of the storage device based on a data size of each DMA descriptor allocated to one operation determined based on the access pattern of the host device.

18. The storage device of claim 10, further comprising a cache memory,
wherein the cache memory is configured to operate based on a size of a cache entry determined based on the access pattern of the host device.

19. A resource management device comprising:
a memory storing instructions to perform a resource management operation; and
at least one processor configured to execute the instructions to:
receive a request from a host device;
determine a unit of data for performing one operation of one or more resources of a storage device based on an access pattern of the host device included in the request and a minimum data unit by which a non-volatile memory included in the storage device operates; and
perform an operation, by the one or more resources of the storage device, based on the determined unit of data.

20. The resource management device of claim 19, wherein each of the one or more resources comprises at least one of a direct memory access (DMA) controller, a cache memory, or a buffer memory.
